(19) United States
(12) Patent Application Publication
(10) Pub. No.: US 2010/0011742 A1
(43) Pub. Date: Jan. 21, 2010

(54) Rocket Motor Containing Multiple Pellet Cells

(76) Inventors: Robert J. Cavalleri, Coral Springs, FL (US); Thomas A. Olden, Tucson, AZ (US)

Correspondence Address: SoCal IP Law Group LLP - Raytheon Company, 310 N. Westlake Blvd. Suite 120, Westlake Village, CA, 91362, US

(21) Appl. No.: 12/175,303

(22) Filed: Jul. 17, 2008

(51) Int. Cl. F02K 9/10; B23P 11/00

(52) U.S. Cl. 60/256; 29/890.01

(57) ABSTRACT

A rocket motor may include a case, a plurality of pellet cells disposed within the case, an igniter disposed to ignite at least one of the pellet cells, and a nozzle coupled to the case. Each pellet cell may contain a corresponding plurality of propellant pellets.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to rocket motors.

2. Description of the Related Art

Solid fuel rocket motors are commonly used in various configurations to propel rockets and missiles. Small solid fuel rocket motors may also be used to control the attitude and steering of a missile, rocket, or other projectile. Small solid fuel rocket motors used to control attitude are commonly called attitude thrusters or divert thrusters. Solid fuel rocket motors may also be used to turn a vertically-launched missile or rocket into near-horizontal flight. Such rocket motors are commonly called pitch-over thrusters.

The thrust or force produced by a rocket motor having an ideally expanded nozzle is given by the equation

F=mₚ*Uₑ
where mₚ=propellant mass flow rate, and

Uₑ=gas velocity at nozzle exit plane.

The propellant mass flow rate mₚ is given by the equation

mₚ=Aₚ*R_{b}*Pₚ
where Aₚ=propellant surface area,

R_{b}=propellant burn rate, and

Pₚ=propellant density.

Thus the propellant surface area Aₚ, the propellant burn rate R_{b} and the propellant density Pₚ are important factors that may be used to determine the thrust produced by a solid fuel rocket.

The force produced by a rocket motor results in a linear or angular acceleration of the missile or other body propelled by the rocket motor. The net change in the linear or angular velocity of the missile or other body is proportional to the force produced by the motor integrated over time. The time integral of the force produced by a rocket motor is commonly called the “impulse” of the motor.

### DESCRIPTION OF THE DRAWINGS

FIG. 1 is a cross-sectional view of a conventional solid fuel rocket motor.

FIG. 2 is a cross-sectional view of a rocket motor incorporating multiple pellet cells.

FIG. 3 is an outline drawing of an exemplary fuel pellet.

FIG. 4 is a cross-sectional view of a rocket motor incorporating multiple pellet cells.

FIG. 5 is a partially-exploded perspective view of a plurality of pellet cells.

FIG. 6 is a partially-exploded perspective view of a plurality of pellet cells.

FIG. 7 is a view of a plurality of pellet cells.

FIG. 8A is a chart showing the performance of a hypothetical rocket motor incorporating multiple pellet cells.

FIG. 8B is a chart showing the performance of a hypothetical rocket motor incorporating multiple pellet cells.

FIG. 8C is a chart showing the performance of a hypothetical rocket motor incorporating multiple pellet cells.

FIG. 9 is a schematic drawing of a family of modular missiles.

FIG. 10 is a flow chart of a process for fabricating a pellet cell.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

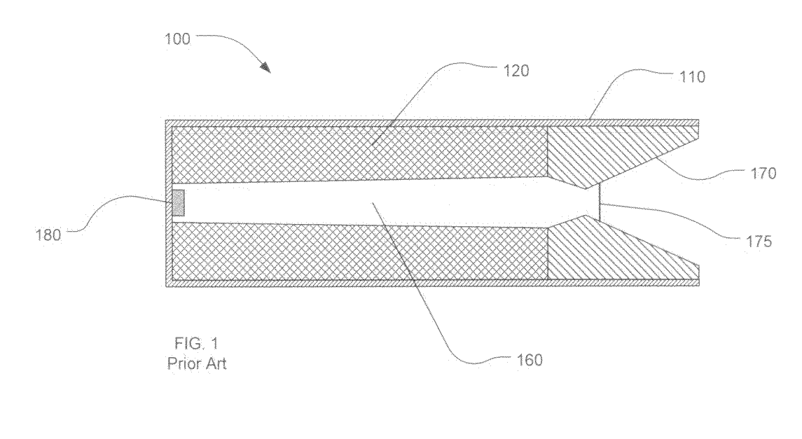

Referring now to the cross-section view of FIG. 1, a solid fuel rocket motor 100 may include a case 110, a solid fuel propellant charge 120 having a longitudinal opening 160, a nozzle 170, and an igniter 180. The solid fuel propellant charge 120 is commonly termed the “grain”, and this term will be used within this description. Note that the term “grain” is used to describe the propellant charge 120 as a whole, but does not refer to the weight of the propellant charge, the particle size of the material composing the propellant charge, or the surface texture of the propellant charge.

In order to provide thrust, the surface area of the solid propellant grain 120 must burn to generate gas. To increase the burnable surface area, a longitudinal cavity 160 may be formed in the grain 120. The longitudinal cavity 160 may commonly be centered on the longitudinal axis of the case 110. Once the grain 130 is ignited by the igniter 180, the burning area may rapidly spread to include the entire surface of the longitudinal cavity 160 and, in some cases, the end of the grain proximate to the nozzle 170. A grain with a longitudinal cavity, such as grain 120 with opening 160, may be termed a “center-perforated grain” or an “inside burning grain”.

The igniter 180 may be a small charge of flammable material that, when burned, releases a predetermined amount of hot combustion gases. The combustion of the igniter may be initiated, for example, by an electric current flowing through a heater wire adjacent to, or embedded in, the flammable igniter material. In order to ignite the grain 120, the temperature and pressure of the gases produced by the igniter 180 must both exceed predetermined values. To allow pressure to build within the cavity 160, and thus facilitate ignition of the grain 120, the cavity 160 may be sealed by an environmental seal 175. The environmental seal 175 may also serve to protect the grain from environmental effects, such as humidity and precipitation.

The environmental seal 175 may be designed to rupture or blow free from the motor after the pressure within the cavity 160 exceeds a predetermined pressure level, which may be, for example, between 100 and 2000 pounds per square inch (PSI). For example, the environmental seal may be retained in the nozzle by means of shear pins that fracture when the pressure exceeds the predetermined level. The environmental seal may be a burst disc having controlled structural weakness that allows the burst disc to rupture in a controlled manner when the pressure exceeds the predetermined level.

To reduce the time required to ignite the entire surface of the grain 120, the cavity 160 may be pressurized with air or another gas to an initial pressure level during manufacture. For example, the initial pressure in the cavity prior to ignition may be 500 to 2000 PSI. In this case, the environmental seal 175 may be designed to retain the initial pressure level indefinitely and to rupture at a substantially higher pressure level after the grain 120 is ignited.

As shown in FIG. 1, the environmental seal 175 may be disposed at or near the portion of the nozzle 170 having the smallest cross-sectional area, commonly termed the throat 142. The environmental seal 175 may be disposed at other locations within the nozzle 170.

Since the ignition of the grain starts at the end proximate to the igniter and then proceeds along the length of the longitudinal cavity, the longitudinal cavity 160 may be tapered slightly, as shown in FIG. 1, to maintain a relatively constant core velocity and minimize erosive burning.

The longitudinal cavity 160 may be shaped as a cylinder or tapered cylinder. To further increase the grain surface area to provide increased thrust, the cross-section of the longitudinal cavity 160 may be a non-circular shape such as a multiply-pointed star, or a circle with radial slots, commonly called a finocyl. A grain with a non-cylindrical longitudinal opening may be difficult to fabricate and may incur stresses that lead to cracking or other deterioration of the grain before and during combustion.

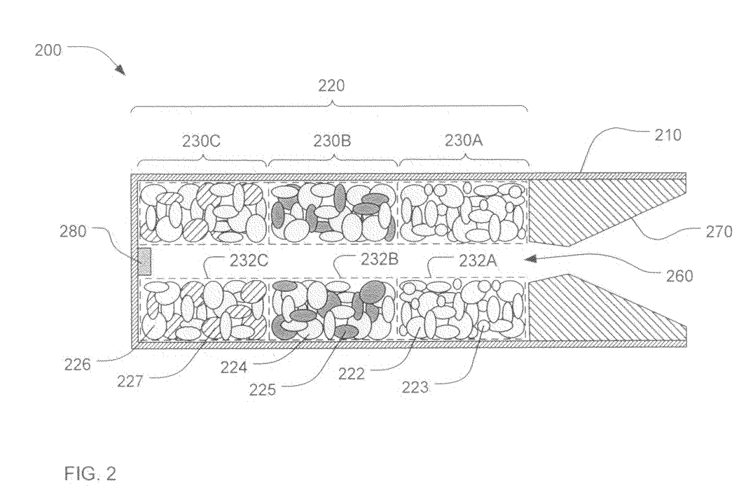

Referring now to FIG. 2, a rocket motor 200 may include a case 210, a propellant charge 220 which may have a longitudinal opening 260, a nozzle 270, and an igniter 280. The propellant charge 220 may be composed of a large plurality (hundreds or thousands) of fuel pellets 222, 223, 224, 225, 226, 227. The fuel pellets 222-7 may be, for example, gas generator pellets that are produced in large quantities for use in automobile air bags.

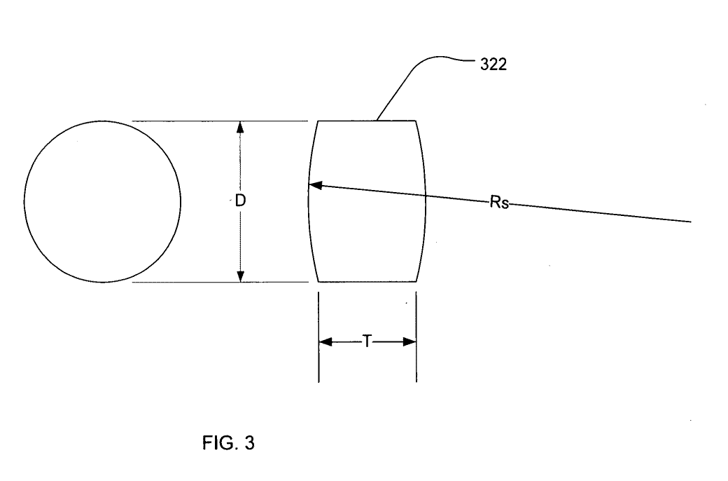

Referring now to FIG. 3, an exemplary fuel pellet 322 may be formed in a shape similar to that of a medicine tablet such as an aspirin. Each fuel pellet 322 may have a diameter D and a thickness T. Each face of the fuel pellet 322 may be convex with a radius Rs. The convex faces may minimize the contact area between adjacent pellets and thus prevent the pellets from stacking or agglomerating. The convex faces may thus ensure that a plurality of pellets such as fuel pellet 322 will have a very large total burnable surface area. Each fuel pellet may be formed in other shapes including flat discs, spheres, elongated cylinders, elongated cylinders with rounded ends, and other shapes.

Each fuel pellet 322 may be composed of at least some of an energetic fuel material and an oxidizer material. Each fuel pellet may contain additional binder and/or plasticizer material. The binder material and the plasticizer material may be reactive and may serve as a fuel material and/or an oxidizer material. Suitable compositions for gas generator pellets are well known. Suitable gas generator compositions include, for example, compositions that are predominantly guanidine (or guanidinium) nitrate and basic copper nitrate, cobalt nitrate, and combinations thereof, as described in U.S. Pat. No. 5,608,183. At least 60% of the total mass of the fuel pellets may be composed of guanidine nitrate and basic copper nitrate. The fuel pellets may have relatively low combustion temperatures, for example between 1500° C. and 2000° C., such that components of the rocket motor that are exposed to the combustion products may be fabricated from Molybdenum or TZM (Titanium-Zirconium-Molybdenum) alloy.

Referring back to FIG. 2, the fuel pellets 222-7 may be disposed within pellet cells 230A, 230B, 230C. Each pellet cell 230A, 230B, 230C may include a respective housing 232A, 232B, 232C enclosing a respective plurality of pellets. While the example of FIG. 2 shows three pellet cells 230A, 230B, 230C, a rocket motor may use more or fewer pellet cells. The number of pellet cells may be determined in consideration of the performance requirements, for example acceleration, speed, and/or range, of the rocket or missile to be powered by the rocket motor. A greater number of pellet cells may provide longer range and/or higher speed compared to a motor having fewer pellet cells.

The fuel pellets 222-227 may be randomly disposed within each pellet cell 320A, 320B, 320C as shown in FIG. 2. Alternatively, the fuel pellets 222-227 may be stacked in an ordered manner (not shown). Many stacking arrangements may be possible depending on the size of the pellet cells and the size and shape of the fuel pellets. To facilitate stacking fuel pellets in an orderly manner, the pellet cells may include rods, guides, or other structure (not shown) to position and retain the stacked pellets.

Within each pellet cell 230A, 230B, 230C, the fuel pellets may all be identical or may be mixture of two or more pellet compositions, shapes, or sizes. For example, pellet cell 230A may be filled with a mixture of larger fuel pellets 222 and smaller fuel pellets 223. For further example, pellet cell 230B may be filled with a mixture of fuel pellets 224 having a first chemical composition and fuel pellets 225 having a second chemical composition.

Some or all of the fuel pellets may be coated with an inhibitor to change the burning characteristics of the fuel pellets. For example, pellet cell 230C may be filled with a mixture of fuel pellets without an inhibitor coating 226 and fuel pellets with an inhibitor coating 227. The inhibitor may be a non-burning or slowly burning organic, inorganic, or composite material that delays the ignition of the coated pellets and thus prolongs the burning time of the rocket motor. The inhibitor coating may be applied by painting, spraying, dipping or bonding.

The combustion versus time profile of a pellet cell may be tailored through selection and combination of multiple fuel pellet sizes, shapes, compositions, and/or inhibitor coatings. Each of the pellet cells 230A, 230B, 230C may be filled with the same or different mixtures of pellets having multiple compositions, shapes, sizes, and/or coatings. The thrust versus time profile of a rocket may be tailored by combining multiple pellet cells having different combustion versus time profiles.

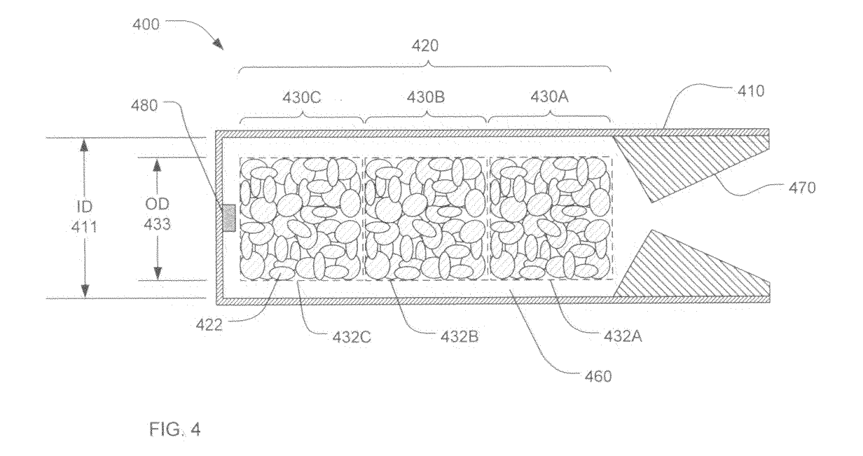

Referring now to FIG. 4, a rocket motor 400 may include a case 410, a propellant charge 420, a nozzle 470, and an igniter 480. The propellant charge 420 may be composed of a large plurality (hundreds or thousands) of fuel pellets 422. The fuel pellets 422 may be, for example, gas generator pellets that are produced in large quantities for use in automobile air bags.

The fuel pellets 422 may be disposed within pellet cells 430A, 430B, 430C. Each pellet cell 430A, 430B, 430C may include a respective housing 432A, 432B, 432C enclosing a respective plurality of pellets. While the example of FIG. 4 shows three pellet cells 430A, 430B, 430C, a rocket motor may use more or fewer pellet cells. The fuel pellets 422 may be randomly disposed within each pellet cell 420A, 420B, 420C or may be stacked in an ordered manner (not shown). The combustion versus time profile of each pellet cell 420A, 420B, 420C may be tailored through selection and combination of multiple fuel pellet sizes, shapes, compositions, and/or inhibitor coatings. Each of the pellet cells 420A, 420B, 420C may be filled with the same or different mixtures of pellets having multiple compositions, shapes, sizes, and/or coatings.

The rocket motor 400 may have a generally cylindrical shape. Each pellet cell 420A, 420B, 420C may have an outside diameter 433 that is smaller than an inside diameter 411 of the case 410. An annular opening 460 may be provided between the outside of the pellet cells 420A, 420B, 420C and the inside of the case 410. The annular opening may provide passage for combustion gases to flow from the pellet cells 420A, 420B, 420C to the nozzle 470.

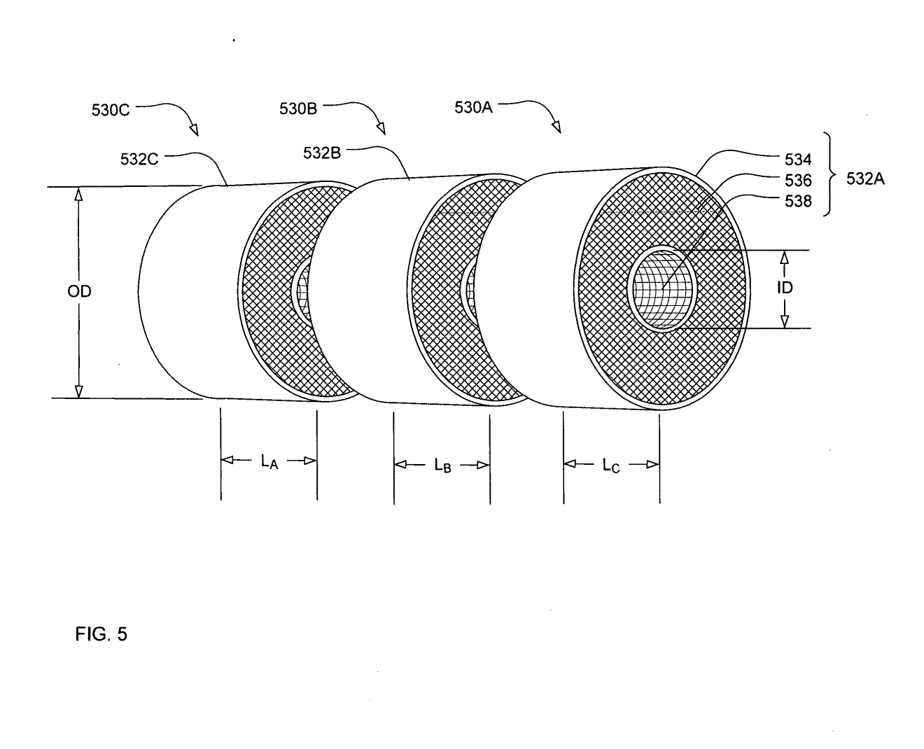

FIG. 5 shows a partially exploded view of a first plurality of pellet cells 530A, 530B, 530C which may be the pellet cells 230A, 230B, 230C. Each pellet cell 530A, 530B, 530C may have a respective housing 532A, 532B, 532C enclosing a respective plurality of fuel pellets (not visible). Each housing 532A, 532B, 532C may be generally cylindrical in shape. Each housing 532A, 532B, 532C may be comprised of an outer cylinder 534, and two end plates of which only end plate 536 is visible. Each housing 532A, 532B, 532C may include an inner cylinder, for example inner cylinder 538 of housing 532A, which may define a longitudinal opening devoid of fuel pellets.

A plurality of pellet cells for use in a rocket motor may have the same size and shape, such that the pellets cells 530A, 530B, 530C may have a common outside diameter OD and the same length (L_{A}=L_{B}=L_{C}). When the pellet cells include an inner cylinder 538 to define a longitudinal opening, the plurality of pellet cells 530A, 530B, 530C may have a common inside diameter ID.

At least a portion of each housing 532A, 532B, 532C may be perforated to allow hot gases produced by combustion of the fuel pellets to escape from the pellet cells. The perforations may be adapted to allow passage for the combustion gasses while retaining unburned and partially burned fuel pellets within the housings. As shown in the example of FIG. 5, the inner cylinder 538 and the end plate 536 may be formed of a woven or etched screen or mesh having openings that allow passage for the combustion gases while retaining the fuel pellets with the housings. Alternatively, all or portions of each housing 532A, 532B, 532C may be formed of a thin sheet material with machined or chemically formed holes (not shown). The perforations may be circular, square, rectangular, elongated slits, or any other shape that allows passage for the combustion gases while retaining the fuel pellets. The term “perforated” is intended to encompass woven screen, etched or formed screen, machined or chemically formed holes, and other types of openings.

The dimensions of the perforations or openings in the housings 532A, 532B, 532C may be significantly smaller than at least one dimension of the smallest fuel pellets in the cell, such that the fuel pellets may not escape from the housings until combustion is nearly complete.

All or portions of the housings 532A, 532B, 532C may be fabricated of a ceramic material, a metal material such as molybdenum or TZM alloy, or another material capable of withstanding the combustion temperatures of the fuel pellets. All or portions of the housings 532A, 532B, 532C may be fabricated of a non-refractory material, such as steel or a reinforced composite material, that cannot directly withstand the combustion temperatures. A non-refractory material may be used for portions of the housings 532A, 532B, 532C if coated with suitable thermal insulating layers. A non-refractory material may be used for portions of the housings 532A, 532B, 532C if the non-refractory portions are thick enough to retain physical integrity for the duration of the rocket motor burn in spite of erosion or other degrading effects of the combustion gases.

The presence of the housings 532A, 532B, 532C may, to some extent, restrict the flow of combustion gases from the burning fuel pellets to the nozzle of the rocket motor (such as nozzle 270). To ensure that the pressure within the rocket motor is governed by the cross-sectional area of the throat within the nozzle, the total cross-sectional area of the perforations or openings in the housings 532A, 532B, 532C may be larger than the cross-section area of the throat.

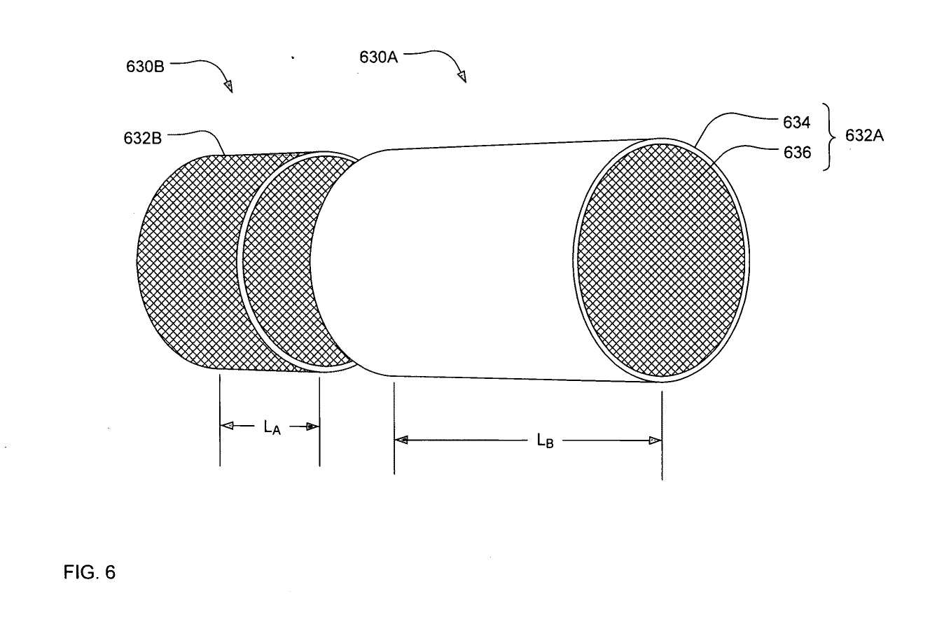

FIG. 6 shows a partially exploded view of a second plurality of pellet cells 630A, 630B which may be the pellet cells 430A and 430B. Each pellet cell 630A, 630B, may have a respective housing 632A, 632B, enclosing a respective plurality of fuel pellets (not visible). Each housing 632A, 632B, may be generally cylindrical in shape. Each housing 632A, 632B may be comprised of an outer cylinder 634, and two end plates such as end plate 636. In contrast to the first plurality of pellets cells 530A, 530B, 530C, the second plurality of pellet cells 630A, 630B may lack a longitudinal opening. In further contrast to the first plurality of pellets cells 530A, 530B, 530C, the second plurality of pellet cells may have a common outside diameter OD but may not have the same length (L_{A}≢L_{B}).

At least a portion of the housings 632A, 632B may be perforated to allow combustion gases to flow out from the respective housings. The end faces, such as end face 636, of each housing may be formed of a woven or etched screen or mesh having openings that allow passage for the combustion gases while retaining the fuel pellets with the housings. Alternatively, all or portions of each housing 632A, 632B may be formed of a thin sheet material with machined or chemically formed holes (not shown). Particularly in the case of pellet cells intended for use within an annular opening (as shown in FIG. 4), the outer cylinder of the housings may be perforated, as shown for housing 632B.

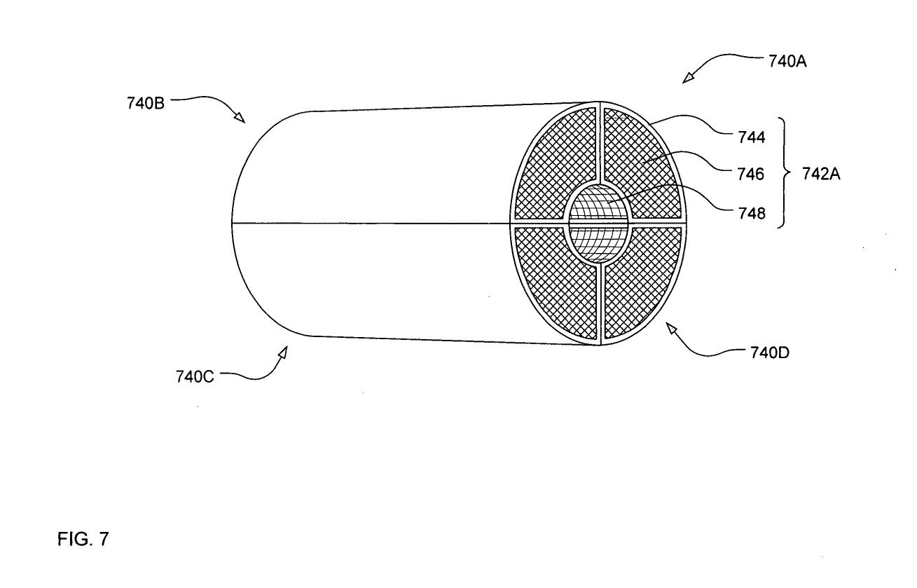

FIG. 7 shows a plurality of pellet cells 740A, 740B 740C, 740D that are not individually cylindrical in shape. Each of the pellet cells 740A, 740B 740C, 740D has a wedge-shaped cross section such that the combination of the four pellet cells forms a cylinder. Each of the pellet cells 740A, 740B 740C, 740D may include a housing, such as housing 742A, composed of an outer element 744, two end faces of which end face 746 is visible, and an optional center element 748 to define a portion of a longitudinal cavity devoid of fuel pellets.

At least a portion of each housing, such as housing 742A, may be perforated to allow combustion gases to flow out of the housing. All or portions of the outer element 744, the end faces such as end face 746, and/or the center element 748 may be perforated.

The plurality of pellet cells shown in each of FIG. 5, FIG. 6, and FIG. 7 had the same cross-sectional shapes such that the pellets cells may be, to at least some extent, physically interchangeable. This is not a requirement. Pellet cells for use in irregularly shaped motors may have differing cross-sectional shapes.

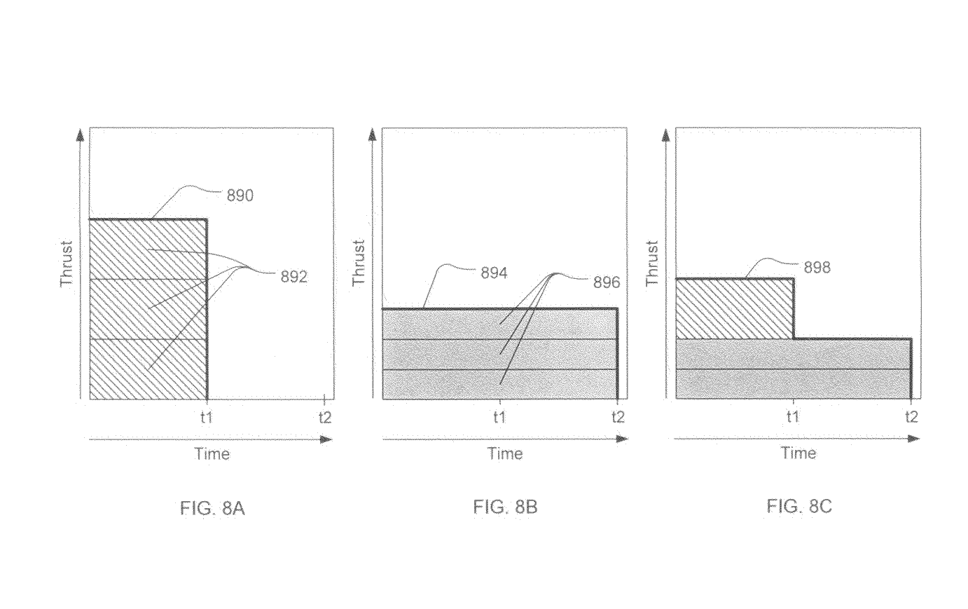

FIG. 8A, FIG. 8B, and FIG. 8C show graphs which plot the idealized thrust, as a function of time, produced by hypothetical rocket motors including three pellet cells containing fuel pellets. For simplicity, the ignition of the fuel pellets is assumed to be instantaneous. Further, the thrust produced by the combustion of the fuel pellets is assumed to be constant from ignition to an instantaneous burn-out.

In FIG. 8A, the bold solid line 890 is a plot of the thrust produced by a first hypothetical rocket motor incorporating three pellet cells. Each of the three pellet cells may produce an impulse indicated by a corresponding one of the three shaded areas 892. Each of the three pellet cells may be filled with a first type of solid fuel pellet.

In FIG. 8B, the bold solid line 894 is a plot of the thrust produced by a second hypothetical rocket motor incorporating three pellet cells. Each of the three pellet cells may produce an impulse indicated by a corresponding one of the three shaded areas 896. Each of the three pellet cells may be filled with a second type of solid fuel pellet. The second hypothetical rocket motor may be similar to the first hypothetical rocket motor except for the type of fuel pellets within the pellet cells. The second type of fuel pellets may have the same or different chemical composition and the same or different size as the first type of fuel pellets. The second type of fuel pellets may be adapted to burn slower than the first type of fuel pellets, such that the second hypothetical rocket motor provides lower thrust for a longer period compared to the first hypothetical rocket motor.

In FIG. 8C, the bold solid line 898 is a plot of the thrust produced by a third hypothetical rocket motor incorporating three pellet cells. One of the pellet cells may be filled with the first type of solid fuel pellet and two of the pellet cells may be filled with the second type of solid fuel pellet. The third hypothetical rocket motor may provide high initial thrust during the burn period of the first type of fuel pellets followed by a lower level of thrust sustained by the combustion of the second type of fuel pellets. The third hypothetical rocket motor may be similar to the first and second hypothetical rocket motors except for the type of fuel pellets within the pellet cells.

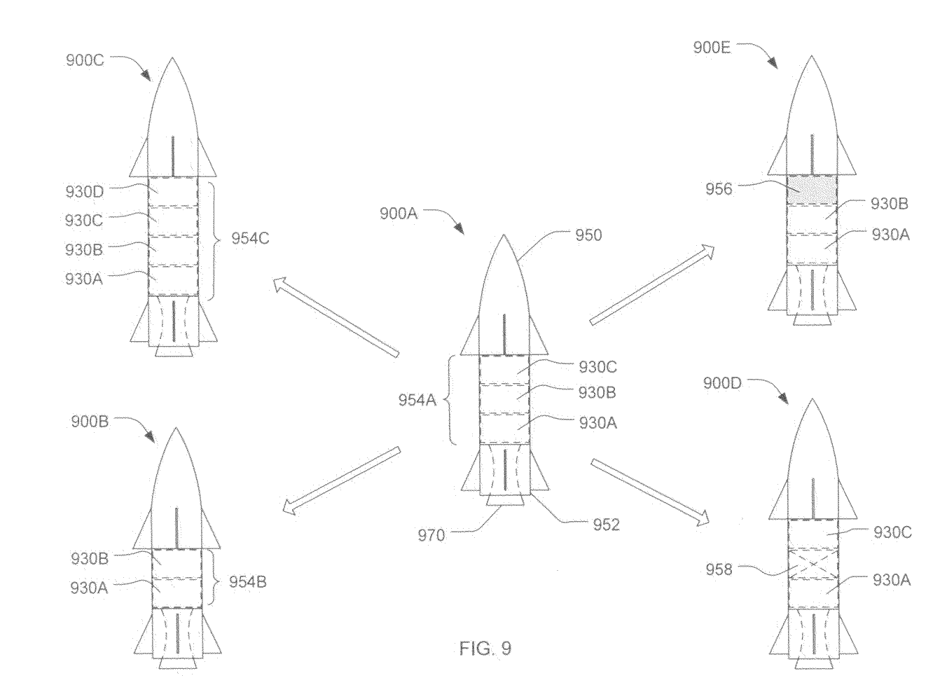

FIG. 9 shows a family of modular missiles including missiles 900A, 900B, 900C, 900D, 900E. Missile 900A may include a forward section 950, a center section 954, and an aft section 952. The forward section 950 may include a seeker or sensor to locate and track targets. The forward section 950 may include a payload such as an explosive warhead. The forward section 950 and/or the aft section 952 may be equipped with aerodynamic surfaces, such as fins, which may be fixed or movable to control the attitude of the missile 900A in flight. The forward section 950 and/or the aft section 952 may contain guidance, navigation, communication, and control electronics. In the example of FIG. 9, the forward section 950 and the aft section 952 may be common to all members of modular missile family.

The center section 954 and the aft section 952 may enclose a rocket motor such as the rocket motor 200. The rocket motor for the missile 900A may include a nozzle 970 extending into or through the aft section 952 and three pellet cells 930A, 930B, 930C.

The missile 900B may be a shorter range variant of the missile 900A. The rocket motor within the missile 900B may include two pellet cells 930A, 930B. The center section 954B of the missile 900B may be correspondingly shorter than the center section 954A of the missile 900A.

The missile 900C may be a longer range variant of the missile 900A. The rocket motor within the missile 900C may include four pellet cells 930A, 930B, 930C, 930D. The center section 954C of the missile 900C may be correspondingly longer than the center section 954A of the missile 900A.

The missile 900D may be a second shorter range variant of the missile 900A. The missile 900A and 900D may be externally identical. The rocket motor within the missile 900C may have two pellet cells 930A, 930C, and a third cell 958 consisting of an empty housing devoid of fuel pellets. Omitting the fuel pellets from one of the three pellet cells may reduce the cost and weight of the shorter range missile 900D. The empty housing may be placed at any position within the motor. Placing the empty housing in the center position, as shown, may minimize the change in the center-of-gravity that may occur as the fuel pellets are burned.

The missile 900E may be a specialized variant of the missile 900A. The missile 900E may have a dual thrust motor providing a thrust versus time profile similar to that shown in FIG. 8C. The rocket motor within the missile 900C may have two pellet cells 930A, 930B including a first type of fuel pellets and a third pellet cell 956 including a second type of fuel pellets.

Description of Processes

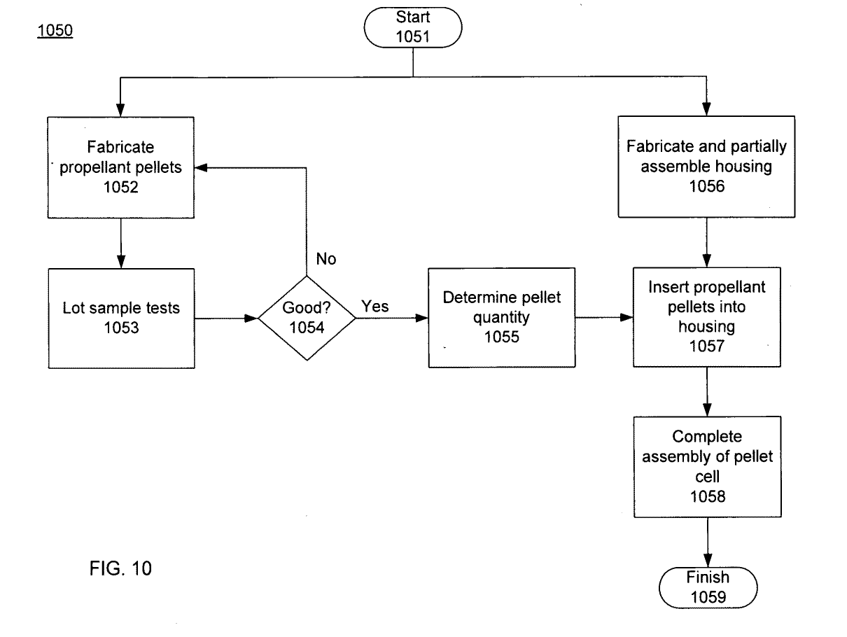

Referring now to FIG. 10, a process 1050 for fabricating a pellet cell starts at 1051 and finishes at 1059. At 1052 fuel pellets may be fabricated or obtained in large lots. At 1053 the performance of each batch of fuel pellets may be verified by lot sample tests, in which randomly selected samples from throughout the lot are tested. At 1054, a determination may be made if the test data from the lot sample tests indicates that the lot of fuel pellets is good and within specification limits.

Assuming the lot of fuel pellets is determined to be good, at 1055, the test data from the lot sample tests may be analyzed to determine the exact quantity of fuel pellets that should be loaded into the pellet cell. The quantity of fuel pellets may be determined as a specific number of pellets or as some other convenient metric such as the total weight or mass of the pellets to be loaded into the pellet cell. For example, the number of fuel pellets loaded into a pellet cell may be reduced from a nominal number of 600 pellets to 595 pellets if the lot sample data indicates that a specific manufacturing lot produced pellets that are more energetic than normal. The ability to adjust the number or weight of the pellets loaded into the pellet cell may allow precise control of the total impulse that may be produced by a rocket motor incorporating the pellet cell.

The pellet cell components, other than the fuel pellets, may be fabricated and partially assembled at 1056. The appropriate quantity of fuel pellets, as determined at 1055, may be added to the partially assembled pellet cell at 1057, and the assembly of the pellet cell may be completed at 1058.

Using the pellet cell 530A of FIG. 5 as an example, the outer cylinder 534, the inner cylinder 538, and one of the two end plates (not visible) may be assembled first at 1056. Next, the fuel pellets may simply be poured into the pellet cell at 1057. At 1058, the assembly of the pellet cell may be completed by assembling the second end plate 536.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A rocket motor comprising
a case
a propellant comprising a plurality of pellet cells disposed within the case
an igniter disposed to ignite at least one of the pellet cells
a nozzle coupled to the case.

2. The rocket motor of claim 1, wherein each pellet cell further comprises:
a housing
a plurality of fuel pellets contained within the housing
wherein the housing is perforated to allow combustion gases to flow from ignited fuel pellets to the nozzle while retaining unburned fuel pellets within the housing.

3. The rocket motor of claim 2, wherein the fuel pellets are disposed randomly within the housing.

4. The rocket motor of claim 2, wherein the fuel pellets are stacked in an ordered manner within the housing

5. The rocket motor of claim 2, wherein the plurality of fuel pellets includes a mixture of fuel pellets selected having at least one of two or more different chemical compositions, two or more different sizes, and pellets with and without an inhibitor coating.

6. The rocket motor of claim 2, wherein each housing defines a cavity devoid of fuel pellets, the cavity adapted to conduct combustion gases from the plurality of fuel pellets directly to the nozzle.

7. The rocket motor of claim 2, wherein the fuel pellets have a combustion temperature below 2000° C.

8. The rocket motor of claim 7, wherein the housing is fabricated, at least in part, from one of molybdenum and TZM alloy.

9. The rocket motor of claim 7, wherein at least 60% of the mass of the fuel pellets is guanidine nitrate and basic copper nitrate.

10. The rocket motor of claim 2, wherein the plurality of pellets cells comprises
one or more first pellet cells, each first pellet cell enclosing a plurality of fuel pellets of a first type
one or more second pellets cells, each second pellet cell enclosing a plurality of fuel pellets of a second type different from the first type.

11. The rocket motor of claim 2, wherein
the case is a generally cylindrical shape having an inside diameter
the housings of the plurality of pellets calls are of generally cylindrical shape having an outside diameter smaller than the inside diameter of the case.

12. The rocket motor of claim 11, wherein
a difference between the inside diameter of the case and the outside diameters of the housings defines an annular passage for combustion gases to flow from the plurality of pellet cells to the nozzle.

13. A pellet cell for a rocket motor comprising
a housing
a plurality of fuel pellets contained within the housing
wherein the housing is perforated to allow combustion gases to flow from ignited fuel pellets to the nozzle while retaining unburned fuel pellets within the housing.

14. The pellet cell of claim 11, wherein the plurality of fuel pellets includes a mixture of fuel pellets including at least one of two or more different chemical compositions, two or more different sizes, and pellets with and without an inhibitor coating.

15. The pellet cell of claim 11, wherein the fuel pellets have a combustion temperature below 2000° C.

16. The pellet cell of claim 13, wherein the housing is fabricated, at least in part, from one of molybdenum and TZM alloy.

17. The pellet cell of claim 13, wherein at least 60% of the mass of the fuel pellets is guanidine nitrate and basic copper nitrate.

18. The pellet cell of claim 11, wherein the plurality of pellets are produced in lots having a lot size substantially larger than the quantity required for a single pellet cell and tested by lot sampling.

19. The pellet cell of claim 16, wherein a quantity of pellets comprising the plurality of pellets is determined from a result of the lot sampling.

20. A process for fabricating a pellet cell, comprising
fabricating and partially assembling a pellet cell housing
adding a predetermined quantity of fuel pellets
completing the assembly of the pellet cell housing.

21. The process for fabricating a pellet cell of claim 18, further comprising
fabricating the fuel pellets in a large lot
confirming the performance of the fuel pellets by lot sample tests
determining the quantity of fuel pellets to be added to the pellet cell based on results of the lot sample tests.

22. A missile comprising:
a rocket motor including
a case
a propellant comprising a plurality of pellet cells disposed within the case
an igniter disposed to ignite at least one of the pellet cells
a nozzle coupled to the case.
